(19) United States
(12) Patent Application Publication
(10) Pub. No.: US 2014/0013317 A1
(43) Pub. Date: Jan. 9, 2014

(54) COMPUTER-READABLE RECORDING MEDIUM, PATCH DETERMINATION METHOD, AND INFORMATION PROCESSING APPARATUS

(71) Applicant: FUJITSU LIMITED, Kawasaki-shi (JP)

(72) Inventors: Tsuyoshi NOSE, Higashiosaka (JP); Makoto Adachi, Akashi (JP); Takashi Sasada, Kobe (JP); Yasuo Sezaki, Akashi (JP); Takayuki Nagai, Kako (JP); Shigeru Fujimoto, Nishinomiya (JP); Masato Yamashita, Kobe (JP); Masaru Yoshida, Kobe (JP)

(73) Assignee: FUJITSU LIMITED, Kawasaki-shi (JP)

(21) Appl. No.: 13/899,771

(22) Filed: May 22, 2013

(30) Foreign Application Priority Data
Jul. 3, 2012 (JP) 2012-149929

(51) Int. Cl. G06F 9/445

(52) U.S. Cl. CPC G06F 8/65
USPC 717/171

(57) ABSTRACT

An administration server executes a process of first acquiring first resource information on a resource used by a function executed on a server to which a patch is to be applied. Then, the administration server executes a process of second acquiring second resource information on a resource accessed by the patch when the patch is executed. Thereafter, based on the first resource information acquired at the first acquiring and the second resource information acquired at the second acquiring, the administration server executes a process of determining whether to apply the patch.

### CROSS-REFERENCE TO RELATED APPLICATION

This application is based upon and claims the benefit of priority of the prior Japanese Patent Application No. 2012-149929, filed on Jul. 3, 2012, the entire contents of which are incorporated herein by reference.

### FIELD

The embodiments discussed herein are related to a patch determination program, a patch determination method, and an information processing apparatus.

### BACKGROUND

Servers have advanced toward higher performance and virtualization, and server management is becoming more and more important. A plurality of virtual servers deployed from one clone master have the same software configuration, but tasks may differ between the servers. Thus, an appropriate patch is applied in accordance with a task.

Although it is desirable to apply all released patches to all of the servers in order also to ensure security, there are patches that affect the task when applied thereto. For this reason, there are known techniques that extract patches to be applied from released patches.

There is known, for example, a technique that identifies places of problems from logs collected when errors of servers have occurred and that extracts a released patch that corrects the places of the problems as a patch to be applied. There is also known a technique that monitors numbers of times of use of modules used on servers and that extracts a candidate to be applied through cross-checking with modified modules to be provided by the released patch. There is further known a technique that monitors numbers of times of access to files on servers, and that extracts, as a candidate to be applied, a patch that corrects packages having files that have been accessed a number of times or more.
Patent Document 1: Japanese Laid-open Patent Publication No. 2010-191527
Patent Document 2: Japanese Laid-open Patent Publication No. 2000-010766
Patent Document 3: International Publication Pamphlet No. WO 2007/105274

However, applying the patch extracted in the above-described technique can adversely affect a task executed by a server. Thus, there is a problem that applying a patch can even cause problems to occur.

Specifically, when a resource used by certain software is modified by applying a patch, an adverse effect may be given to other software that uses the modified resource.

For example, when a patch is applied to software A in which a failure has occurred while the software A has been operating in conjunction with software B, the application of the patch may cause a failure to occur in the software B cooperating with the software A. Therefore, simply applying the released patch that corrects the places of the problems can induce another problem, and thus is insufficient.

In addition, when a patch is applied to a package appointed to be a candidate to be patched, an adverse effect may be given to other cooperating software in execution of a task having the package as a component. Therefore, a problem can be induced by simply appointing, as a candidate to be applied, a patch that corrects the packages having files that have been accessed a number of times or more. Thus, this method is insufficient. In the same manner, it is insufficient to simply appoint, as a candidate to be applied, a patch that corrects the modules that have been used many times.

### SUMMARY

According to an aspect of an embodiment, a non-transitory computer-readable recording medium having stored therein a patch determination program causing a computer to execute a process includes: first acquiring first resource information on a resource used by a function executed on an information processing apparatus to which a patch is to be applied; second acquiring second resource information on a resource accessed by the patch when the patch is executed; and determining whether to apply the patch, based on the first resource information acquired at the first acquiring and the second resource information acquired at the second acquiring.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a diagram illustrating an overall configuration example of a system according to a first embodiment of the present invention;

FIG. 2 is a functional block diagram illustrating functional configurations of apparatuses constituting the system according to the first embodiment;

FIG. 3 is a diagram illustrating an example of information stored in a function definition DB;

FIG. 4 is a diagram illustrating an example of information stored in a function use resource DB;

FIG. 5 is a diagram illustrating an example of information stored in a function log DB;

FIG. 6 is a diagram illustrating an example of information stored in a function use status DB;

FIG. 7 is a diagram illustrating an example of information stored in a patch access resource DB;

FIG. 8 is a diagram illustrating an example of a determination result stored in a patch cross-check result DB for a patch O2 with respect to a virtual server A;

FIG. 9 is a diagram illustrating an example of a determination result stored in the patch cross-check result DB for a patch C1 with respect to the virtual server A;

FIG. 10 is a diagram illustrating policies for patch application determination;

FIG. 11 is a diagram illustrating display examples displayed on a display unit;

FIG. 12 is a flowchart illustrating a flow of a function definition process;

FIG. 13 is a flowchart illustrating a flow of a process to identify resources used by functions;

FIG. 14 is a flowchart illustrating a flow of a process to collect logs;

FIG. 15 is a flowchart illustrating a flow of a process to analyze used functions;

FIG. 16 is a flowchart illustrating a flow of a process to identify resources accessed by patches;

FIG. 17 is a flowchart illustrating a flow of a process to determine whether patches are to be applied; and

FIG. 18 is a diagram illustrating a hardware configuration example of a computer.

### DESCRIPTION OF EMBODIMENTS

Preferred embodiments of the present invention will be explained with reference to accompanying drawings.

Note that the present invention is not limited by the embodiments.

### [a] First Embodiment

Overall Configuration

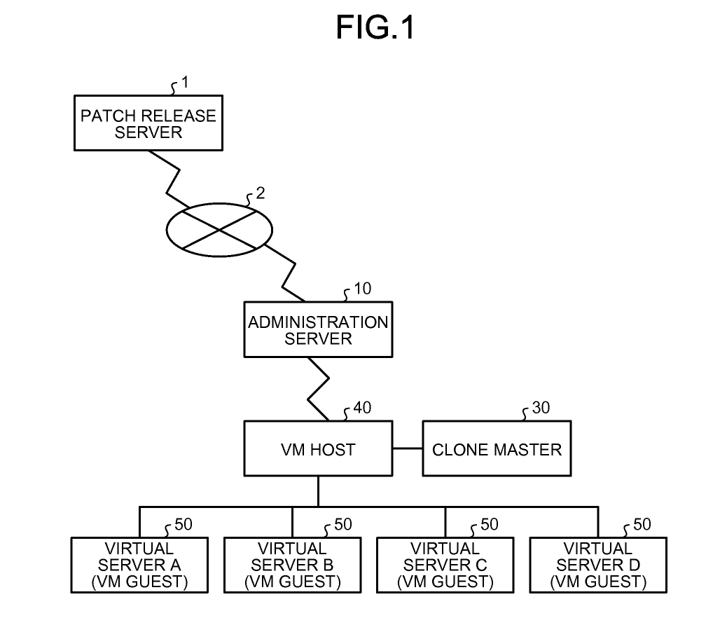

FIG. 1 is a diagram illustrating an overall configuration example of a system according to a first embodiment of the present invention. As illustrated in FIG. 1, the system includes a patch release server 1, an administration server 10, a clone master 30, a virtual machine (VM) host 40, a virtual server A, a virtual server B, a virtual server C, and a virtual server D. Note that all of the virtual servers have the same configuration, and therefore, are mentioned as virtual servers 50.

The patch release server 1 is a server device that is connected to the administration server 10 via a public network 2 or the like and that periodically releases patches. The administration server 10 is a server device that is connected to the patch release server 1 via the public network 2 or the like and that is connected to the VM host 40 via a network. The administration server 10 acquires the periodically released patches from the patch release server 1 and determines whether to apply the released patches to the virtual servers 50.

The clone master 30 is a copy source used in the case of deploying the virtual servers 50. That is to say, the clone master 30 and the virtual servers 50 have the same operating system (OS) and the same software configuration. The VM host 40 is a server that deploys VM guests and copies thereto the software configuration and the like of the clone master 30.

The virtual servers 50 are virtual servers deployed as copies of the clone master 30 serving as the copy source, and function as the VM guests. All of the virtual servers 50 have the same software configuration. The virtual servers 50 are assumed to execute different tasks. In other words, functions executed on each of the virtual servers 50 are not necessarily the same. The clone master 30 and each of the virtual servers 50 may be implemented in the same physical server, or may be implemented in separate physical servers.

In the above-described state, the administration server 10 acquires first resource information that indicates information on resources used by functions executed on the virtual servers 50 to be patched. Then, the administration server 10 acquires second resource information that indicates information on resources accessed by the patch when the patch is executed. Thereafter, based on the first resource information and the second resource information, the administration server 10 determines whether to apply the patch.

As a result, the administration server 10 can determine whether to apply the patch based on whether the patch accesses the resources used by the functions of the virtual servers to be patched. Therefore, the administration server 10 can determine whether to apply the patch taking into consideration an influence on the task, and thus can prevent problems from occurring due to application of the patch.

Configurations of Apparatuses

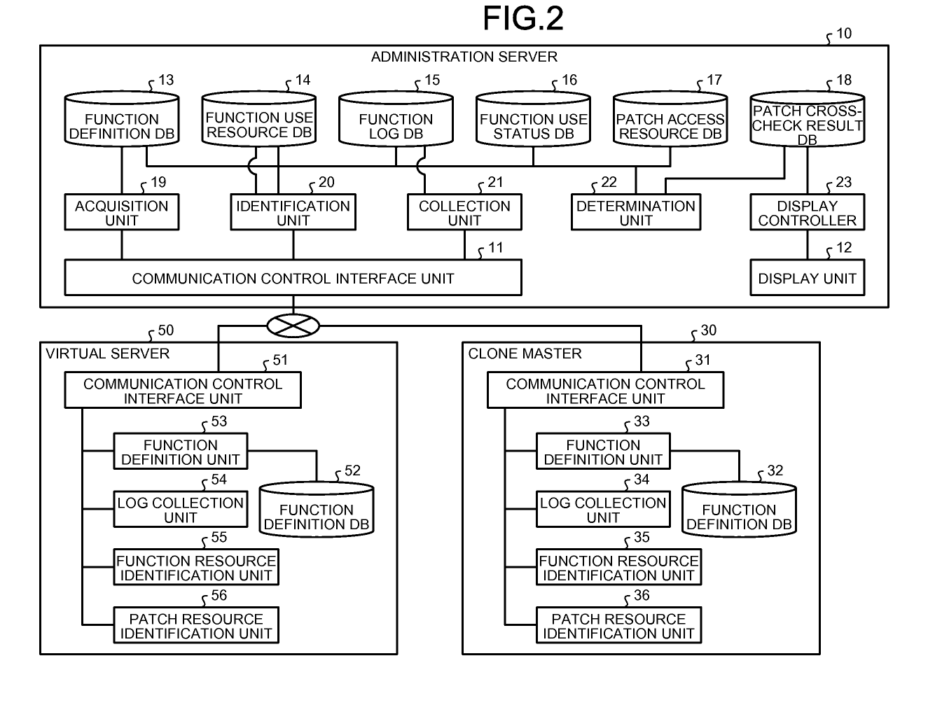

Next, using FIG. 2, a description will be made of configurations of apparatuses included in the system illustrated in FIG. 1. FIG. 2 is a functional block diagram illustrating the functional configurations of the apparatuses constituting the system according to the first embodiment. Note that the patch release server 1 has the same functions as those of general patch release servers, and therefore, the description will be made here of the administration server 10, the clone master 30, and the virtual servers 50.

Configuration of Administration Server

As illustrated in FIG. 2, the administration server 10 includes a communication control interface 11, a display unit 12, a function definition DB 13, a function use resource DB 14, a function log DB 15, a function use status DB 16, a patch access resource DB 17, and a patch cross-check result DB 18. The administration server 10 also includes an acquisition unit 19, an identification unit 20, a collection unit 21, a determination unit 22, and a display controller 23. Note that the DBs are stored in a storage device such as a memory, a hard disk, or the like. Each of the processing units is executed by a central processing unit (CPU) or the like.

The communication control interface 11 is a processing unit that controls communication with other servers. For example, the communication control interface 11 receives a released patch from the patch release server 1. The communication control interface 11 also receives a function definition from the clone master 30, and receives logs from the virtual servers 50. In addition, the communication control interface 11 sends the released patch to the virtual servers 50.

The display unit 12 is a display medium, such as a display or a touch panel, that displays various types of information. The display unit 12 displays, for example, a cross-check result for a patch, based on an instruction operation of the display controller 23.

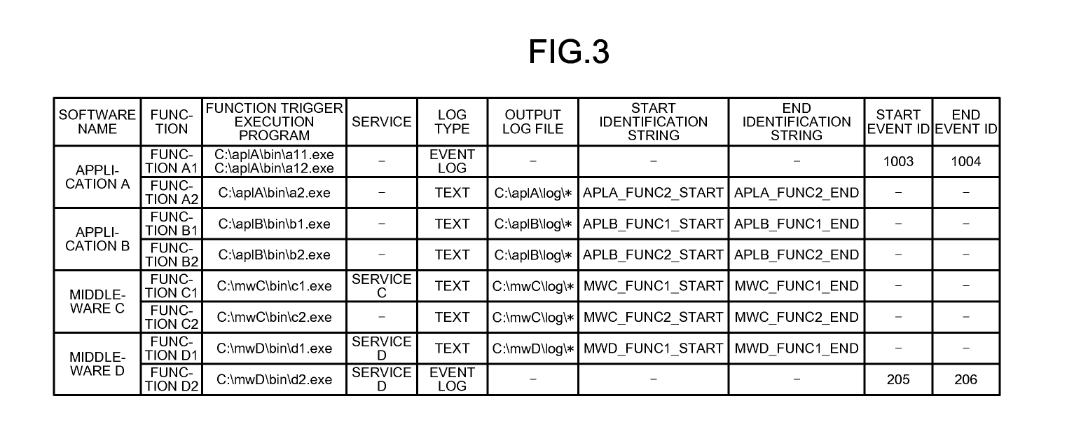

The function definition DB 13 is a storage unit that stores therein definitions about available functions installed on the clone master. The term “functions” here refers to software, middleware, applications, commands, services, and the like. The information stored here is stored by the acquisition unit 19 or the like. FIG. 3 is a diagram illustrating an example of the information stored in the function definition DB. As illustrated in FIG. 3, the function definition DB 13 stores therein items of “software name, function, function trigger execution program, service, log type, output log file, start identification string, end identification string, start event ID, and end event ID” in a mutually corresponding manner.

The “software name” stored here is set with a name of software that provides a function. The “function” is set with the name of the function providing a task. The “function trigger execution program” is set with a name of an execution program that provides the function. The “service” is set with a name of a service provided by the function. The “log type” is set with a type of a log output by the function. The “output log file” is set with the file name of the log output by the function. The “start identification string” is set with a string that identifies the start of the log output by the function. The “end identification string” is set with a string that identifies the end of the log output by the function. The “start event ID” is set with an ID that identifies the start of an event log output by the function. The “end event ID” is set with an ID that identifies the end of the event log output by the function.

The first row of FIG. 3 will be specifically described as an example. The first row indicates that a function A1 provided by an application A is a function executed by “C:¥aplA¥bin¥a11.exe” and “C:¥aplA¥bin¥a12.exe”. The first row also indicates that the function A1 outputs logs to an event log, and that the event log starts at ID=1003 while the event log ends at ID=1004.

Next, the fifth row of FIG. 3 will be specifically described as another example. The fifth row indicates that a function C1 provided by middleware C is a function executed by “C:¥mwC¥bin¥c1.exe” and provides Service C. Also, the function C1 outputs text type logs to “C:¥mwC¥log¥*”. Among the logs output to “C:¥mwC¥log¥*”, “MWC_FUNC1_START” indicates the start of the function C1, and “MWC_FUNC1_END” indicates the end of the function C1.

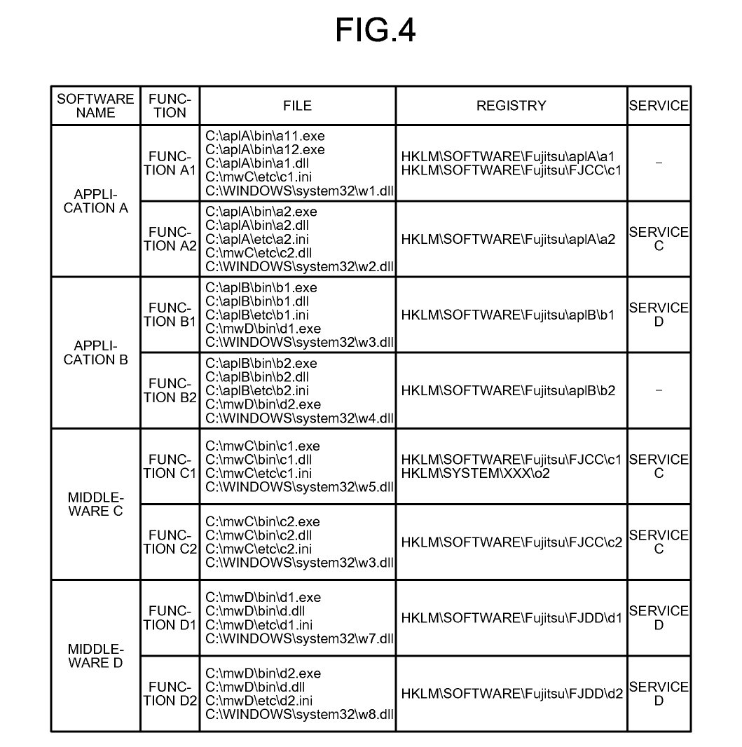

Referring back to FIG. 2, the function use resource DB 14 is a storage unit that stores therein the information on the resources used by the functions. The term “resources” here refers to files, registries, services, and the like. The term “service” refers to a process resident on the server, and corresponds, for example, to a daemon process of UNIX (registered trademark). The term “used” refers to “referred to”, “added”, “updated”, or “deleted” when the resource is a file or a registry, or refers to “communicated” when the resource is a service. The information stored here is stored by the identification unit 20 or the like. FIG. 4 is a diagram illustrating an example of information stored in the function use resource DB. As illustrated in FIG. 4, the function use resource DB 14 stores therein items of “software name, function, file, registry, and service” in a mutually corresponding manner.

The “software name” stored here is set with the name of software that provides the function. The “function” is set with the name of the function providing a task. The “file” is set with a name of a file used by the function. The “registry” is set with a name of a registry used by the function. The “service” is set with a name of a service used by the function. Note that the items of “file, registry, and service” may be managed as separate resources based on the types of the resources, such as resources used by applications, resources used by middleware, and resources used by the OS.

The first row of FIG. 4 will be specifically described as an example. In the case of the first row, the function A1 provided by the application A uses five files of “C:¥aplA¥bin¥a11.exe”, “C:¥aplA¥bin¥a12.exe”, “C:¥aplA¥bin¥a1.dll”, “C:¥mwC¥etc¥c1.ini”, and “C:¥WINDOWS¥system32¥w1.dll”. The function A1 provided by the application A also uses two registries of “HKLM¥SOFTWARE¥Fujitsu¥aplA¥a1” and “HKLM¥SOFTWARE¥Fujitsu¥FJCC¥c1”.

Next, the fifth row of FIG. 4 will be specifically described as another example. In the case of the fifth row, the function C1 provided by the middleware C uses four files of “C:¥mwC¥bin¥c1.exe”, “C:¥mwC¥bin¥c1.dll”, “C:¥mwC¥etc¥c1.ini”, and “C:¥WINDOWS¥system32¥w5.dll”. The function C1 provided by the middleware C also uses two registries of “HKLM¥SOFTWARE¥Fujitsu¥FJCC¥c1” and “HKLM¥SYSTEM¥XXX¥o2”. The function C1 provided by the middleware C further uses “Service C”.

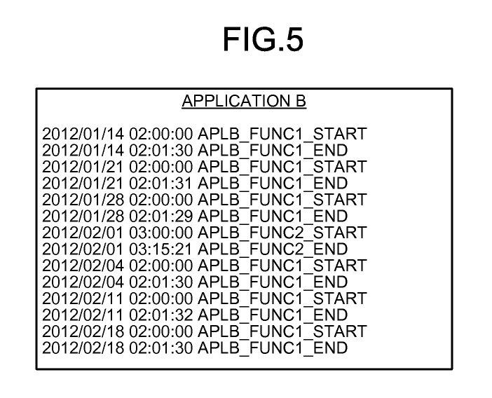

Referring back to FIG. 2, the function log DB 15 is a storage unit that stores therein the logs acquired from the virtual servers 50. The function log DB 15 stores therein the logs of the virtual servers 50 on a server-by-server basis. The information stored here is stored by the collection unit 21. FIG. 5 is a diagram illustrating an example of the information stored in the function log DB.

The information illustrated in FIG. 5 is information that is stored in a log file output by an application B of the virtual servers 50. Logs “2012/02/01 3:00:00 APLB_FUNC2_START” and “2012/02/01 3:15:21 APLB_FUNC2_END” are output to the log file illustrated in FIG. 5. Referring to FIG. 3, these logs are found to be logs output by a function B2 of the application B. Accordingly, it is found that the function B2 of the application B started at “2012/02/01 3:00:00” and ended at “2012/02/01 3:15:21”.

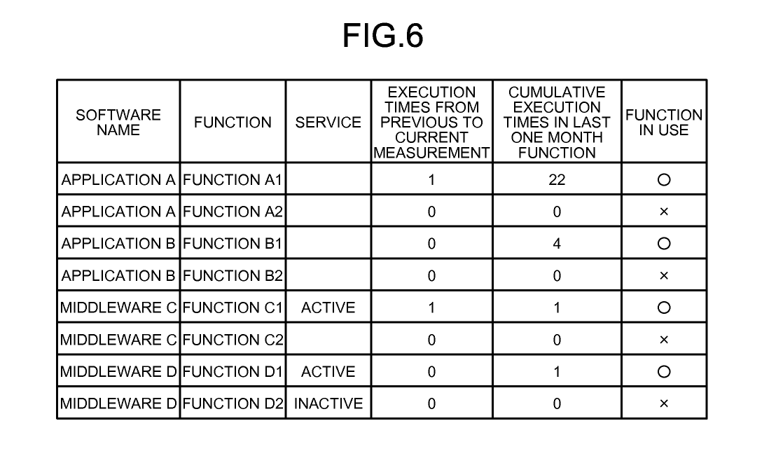

The function use status DB 16 is a storage unit that stores therein use statuses of functions that have been executed on the virtual servers. The information stored here is stored by the identification unit 20 or the like. FIG. 6 is a diagram illustrating an example of the information stored in the function use status DB. FIG. 6 illustrates, as an example, the use information on the functions that have been executed on the virtual server A. As illustrated in FIG. 6, the function use status DB 16 stores therein items of “software name, function, service, execution times from previous to current measurement, cumulative execution times in last one month, and function in use” in a mutually corresponding manner.

The “software name” stored here is set with the name of software that provides the function. The “function” is set with the name of the function providing a task. The “service” is set with information on whether the service provided by the function is active or inactive. The “execution times from previous to current measurement” is set with the number of times the function has been executed during the time from the previous to the current measurement. The number of “cumulative execution times in last one month” is set with the number of times the function has been executed in the last one month. The “function in use” is set with information on whether the function is in use, that is, set with an O mark when the function is in use, or set with an X mark when the function is not in use.

The first row of FIG. 6 will be specifically described as an example. The first row indicates that the function A1 provided by the application A has been executed once during the time from the previous to the current measurement, that the number of times the function has been executed in the last one month is 22, and that the function is currently in use. The fifth row of FIG. 6 will be specifically described as another example. The fifth row indicates that the service of the function C1 provided by the middleware C is active. The fifth row further indicates that the function C1 has been executed once during the time from the previous to the current measurement, that the number of times the function has been executed in the last one month is one, and that the function is currently in use.

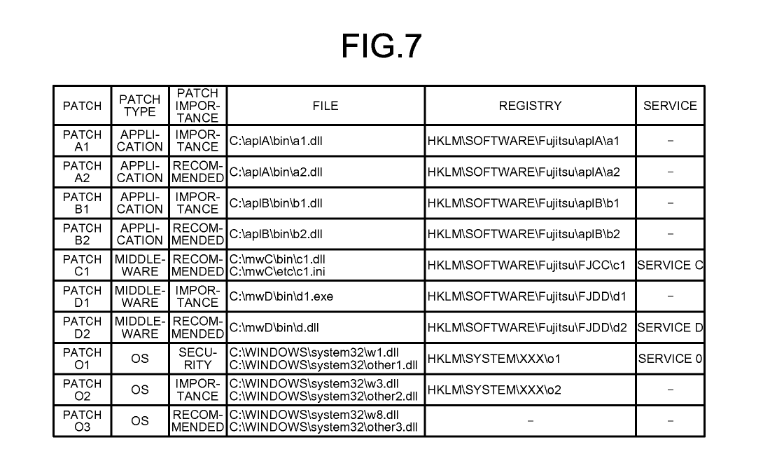

The patch access resource DB 17 stores therein the information on the resources accessed by the released patches on a patch-by-patch basis. The term “accessed” refers to “referred to”, “added”, “updated”, or “deleted” when the resource is the file or the registry, or refers to “active” or “inactive” when the resource is the service. The information stored here is stored by the identification unit 20 or the like. FIG. 7 is a diagram illustrating an example of the information stored in the patch access resource DB. As illustrated in FIG. 7, the patch access resource DB 17 stores therein items of “patch, patch type, patch importance, file, registry, and service” in a mutually corresponding manner.

The “patch” stored here is set with a name of a patch released by the patch release server 1. The “patch type” is set with the type of the released patch. The “patch importance” is set with the importance of the released patch. The “file” is set with a name of a file accessed by the released patch when the patch is executed. The “registry” is set with a name of a registry accessed by the released patch when the patch is executed. The “service” is set with a name of a service accessed by the released patch when the patch is executed. Note that the items of “patch, patch type, and patch importance” can be acquired from the released patch, and the other items of information can be acquired by executing the patch in a testing environment or the like.

The first row of FIG. 7 will be specifically described as an example. The first row indicates that a patch A1 is a patch that corrects an application and that the importance of the patch A1 is classified as important. The first row indicates that the patch A1 accesses the file “C:¥aplA¥bin¥a1.dll” and the registry “HKLM¥SOFTWARE¥Fujitsu¥aplA¥a1”.

Next, the eighth row of FIG. 7 will be specifically described as another example. The eighth row indicates that a patch O1 is a patch that corrects the OS, and that the importance of the patch O1 is classified as security. The eighth row indicates that the patch O1 accesses files “C:¥WINDOWS¥system32¥w1.dll” and “C:¥WINDOWS¥system32¥other1.dll”. The eighth row also indicates that the patch O1 accesses a registry “HKLM¥SYSTEM¥XXX¥o1” and a service “Service O”.

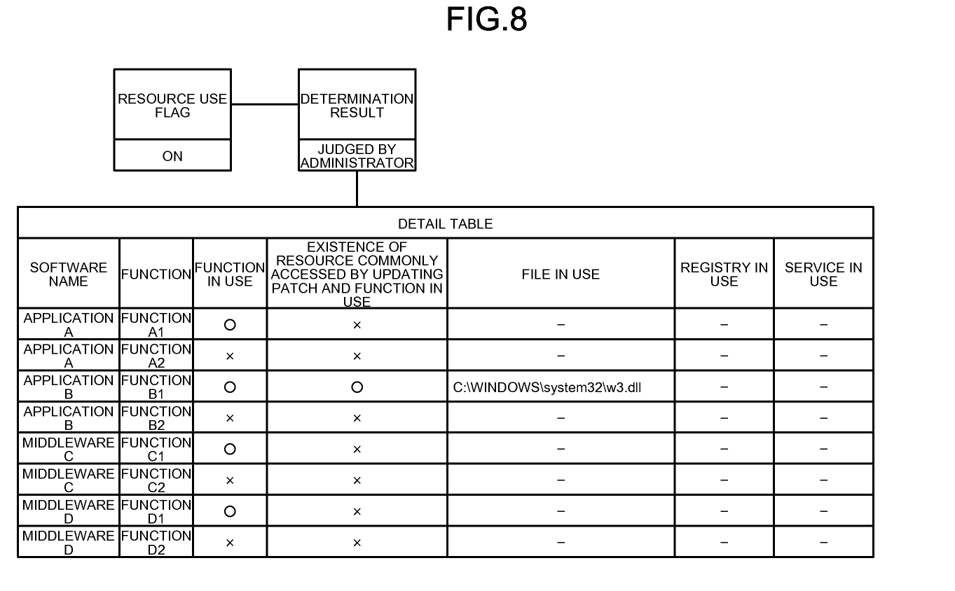

Referring back to FIG. 2, the patch cross-check result DB 18 is a storage unit that stores therein a determination result whether to apply a released patch to the virtual servers 50 on a patch-by-patch basis. The information stored here is stored by the determination unit 22 or the like. FIG. 8 is a diagram illustrating an example of the determination result stored in the patch cross-check result DB for a patch O2 with respect to the virtual server A. As illustrated in FIG. 8, the patch cross-check result DB 18 stores a “resource use flag”, the “determination result”, and a “detail table” in a mutually corresponding manner.

The “resource use flag” stored here is set with information on whether there is a function that uses resources accessed by the patch, that is, set with ON when there is a function, or set with OFF when there is no function. The “resource use flag” is set based on the “detail table” described below. The “determination result” is set with information on whether to apply the patch, that is, set with, for example, “judged by administrator”, “unnecessary to apply”, or “necessary to apply”.

The “detail table” lists items of “software name, function, function in use, existence of resource commonly accessed by updating patch and function in use, file in use, registry in use, and service in use” in a mutually corresponding manner.

The “software name” is set with the name of software that provides the function. The “function” is set with the name of the function providing a task. The “function in use” is set with information on whether the function is in use, that is, set with an O mark when the function is in use, or set with an X mark when the function is not in use. The “existence of resource commonly accessed by updating patch and function in use” is set with information on whether the resource accessed by the patch and the resource accessed by the function are coincident with each other, that is, set with an O mark when they are coincident, or set with an X mark when they are not coincident. The “file in use” is set with a name of a file commonly used by the patch and the function. The “registry in use” is set with a name of a registry commonly used by the patch and the function. The “service in use” is set with a name of a service commonly used by the patch and the function.

In the “detail table” in FIG. 8, a file “C:¥WINDOWS¥system32¥w3.dll” used by a function B1 of the application B that is in use coincides with the file “C:¥WINDOWS¥system32¥w3.dll” accessed by the patch O2 illustrated in FIG. 7. As a result, the resource use flag is set with “ON”, and the determination result is set with “judged by administrator”.

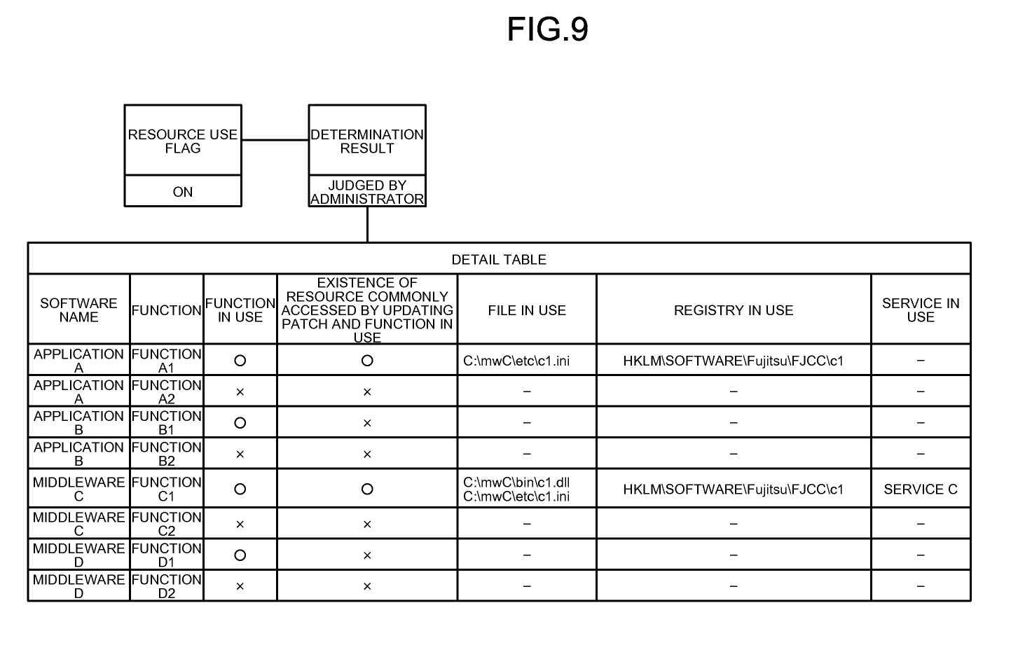

FIG. 9 is a diagram illustrating an example of a determination result stored in the patch cross-check result DB for a patch C1 with respect to the virtual server A. The configuration of the information illustrated in FIG. 9 is the same as that in FIG. 8, and detail description thereof will be omitted. As illustrated in FIG. 9, the file “C:¥mwC¥etc¥c1.ini” used by the function A1 of the application A that is in use coincides with the file “C:¥mwC¥etc¥c1.ini” accessed by the patch C1 illustrated in FIG. 7. Also, the registry “HKLM¥SOFTWARE¥Fujitsu¥FJCC¥c1” used by the function A1 of the application A that is in use coincides with the registry “HKLM¥SOFTWARE¥Fujitsu¥FJCC¥c1” accessed by the patch C1.

In addition, files “C:¥mwC¥bin¥c1.dll” and “C:¥mwC¥etc¥c1.ini” used by the function C1 of the middleware C that is in use coincide with the files “C:¥mwC¥bin¥c1.dll” and “C:¥mwC¥etc¥c1.ini”, respectively, accessed by the patch C1. Also, the registry “HKLM¥SOFTWARE¥Fujitsu¥FJCC¥c1” used by the function C1 of the middleware C that is in use coincides with the registry “HKLM¥SOFTWARE¥Fujitsu¥FJCC¥c1” accessed by the patch C1. Furthermore, the service “Service C” used by the function C1 of the middleware C that is in use coincides with the service “Service C” accessed by the patch C1. As a result of these facts, the resource use flag is set with “ON”, and the determination result is set with “judged by administrator”.

The acquisition unit 19 is a processing unit that acquires definition information on functions from the virtual servers, and stores the acquired information in the function definition DB 13. For example, the acquisition unit 19 can acquire the information defined in the clone master 30, or a user can manually set the definition information.

The identification unit 20 is a processing unit that identifies the information on the resources used when the functions are executed, and stores the identified information in the function use resource DB 14. For example, the identification unit 20 makes the clone master 30 execute functions executable on the virtual servers 50 to be patched, and acquires the information on the resources accessed by the functions.

The identification unit 20 is also a processing unit that identifies the use statuses of the functions installed on the virtual servers, and stores the identified use statuses in the function use status DB 16. For example, the identification unit 20 identifies the functions used on each of the virtual servers 50 by checking, on a server-by-server basis, whether logs of the functions stored in the function definition DB 13 are output to logs stored in the function log DB 15, and stores the identified results. To take an example, if an item “event ID=1003” exists among the event logs collected with respect to the virtual server A, the identification unit 20 identifies that the function A1 of the application A is used on the virtual server A. In this case, the identification unit 20 increments by one each of the numbers of times of execution in the function use status DB 16, and sets the “function in use” with an O mark.

The identification unit 20 is also a processing unit that identifies the information on resources accessed by a patch when a program for applying the patch is executed, and stores the identified information in the patch access resource DB 17. For example, the identification unit 20 acquires a patch released from the patch release server 1. Then, the identification unit 20 executes the acquired released patch on the clone master 30 to acquire resources accessed by the released patch, and stores the information on the resources in the patch access resource DB 17. To take an example, when a file “C:¥aplA¥bin¥a1.dll” is corrected by the patch A1 that is a released patch executed on the clone master 30, the identification unit 20 stores “C:¥aplA¥bin¥a1.dll” as a file accessed by the patch A1 in the patch access resource DB 17.

The collection unit 21 is a processing unit that collects the event logs and the log files from the virtual servers 50. For example, the collection unit 21 periodically collects the event logs from the virtual servers 50, and stores the collected event logs in the function log DB 15. The collection unit 21 also collects the output log files stored in the function definition DB 13 from the virtual servers 50, and stores the collected output log files in the function log DB 15.

To take an example, the collection unit 21 accesses the virtual server A to determine whether the virtual server A has output log files “C:¥aplB¥log¥*” output by the function B1 of the application B. Then, if the virtual server A has the output log files “C:¥aplB¥log¥*”, the collection unit 21 acquires the output log files “C:¥aplB¥log¥*”. Thereafter, the collection unit 21 stores the acquired output log files “C:¥aplB¥log¥*” in the function log DB 15, in a manner in which the acquired output log files correspond to an identifier that identifies that the collection source is the virtual server A.

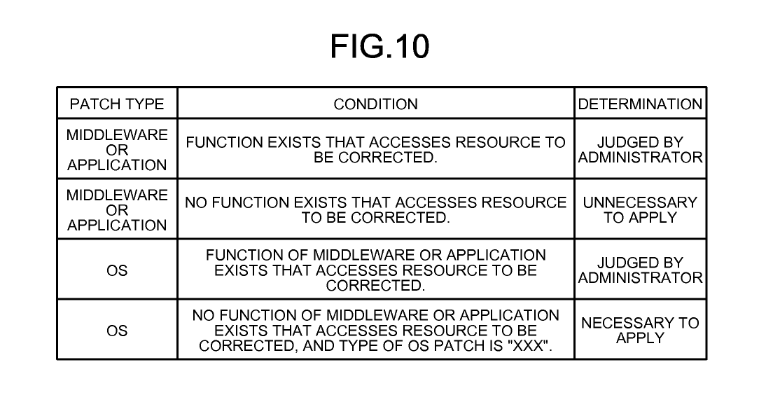

The determination unit 22 is a processing unit that determines whether to apply a patch, based on the information on resources used by functions executed on the servers to be patched and on the information on resources accessed by the patch. Specifically, the determination unit 22 generates the detail table of the patch cross-check result DB 18 based on the function use resource DB 14, the function use status DB 16, and the patch access resource DB 17. Then, based on the detail table and on policies for patch application determination, the determination unit 22 generates the determination result of the patch cross-check result DB 18. FIG. 10 is a diagram illustrating the policies for patch application determination. The policies illustrated in FIG. 10 are merely examples, and can be changed to any settings.

As illustrated in FIG. 10, regarding the middleware and applications, it is determined as being “judged by administrator” if any function exists that accesses the resource to be corrected that is to be accessed by the patch. Regarding the middleware and applications, it is instead determined as “unnecessary to apply” if no function exists that accesses the resource to be corrected that is to be accessed by the patch. In the same manner, regarding the OS, it is determined as being “judged by administrator” if any function of middleware or an application exists that accesses the resource to be corrected that is to be accessed by the patch. Regarding the OS, it is instead determined as “necessary to apply” if no function of middleware or application exists that accesses resource to be corrected that is to be accessed by the patch, and if the type of the OS patch is a type specified in advance. Note that there are types of the OS patches such as an “important” type, and the policies are prepared in accordance with the types of OS patches.

Here, a description will be made of an example of determining whether to apply the patch O2 whose patch type is “OS” to the virtual server A. The determination unit 22 refers to the patch access resource DB 17 illustrated in FIG. 7, and identifies files “C:¥WINDOWS¥system32¥w3.dll” and “C:¥WINDOWS¥system32¥other2.dll” and the registry “HKLM¥SYSTEM¥XXX¥o2” that are accessed by the patch O2. Subsequently, the determination unit 22 refers to the function use resource DB 14 illustrated in FIG. 4, and identifies a function that is set with a file or a resource coinciding with a file or a resource accessed by the patch O2. Here, the determination unit 22 identifies the function B1 of the application B that accesses the file “C:¥WINDOWS¥system32¥w3.dll”. The determination unit 22 further refers to the function use status DB 16 illustrated in FIG. 6, and identifies that the “function in use” of the identified function B1 of the application B is set with an O mark.

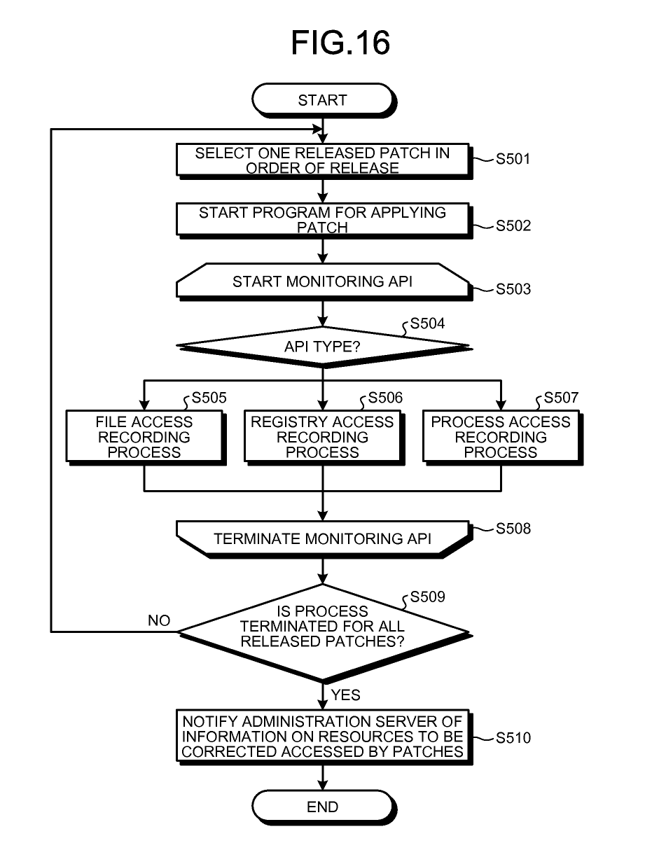

Thereafter, the determination unit 22 extracts items of the software name, the function, and the function in use from the function use status DB 16 illustrated in FIG. 16, and stores them in the patch cross-check result DB 18. Furthermore, regarding the function B1 of the application B, the determination unit 22 sets the “existence of resource commonly accessed by updating patch and function in use” with “O” and sets the “name of file in use” with “C:¥WINDOWS¥system32¥w3.dll”.

Regarding the function B1 of the application B, the “existence of resource commonly accessed by updating patch and function in use” is set with “O”, and the “function in use” is set with “O”. Therefore, the determination unit 22 then sets the “resource use flag” to “ON”. Furthermore, the determination unit 22 refers to the policies illustrated in FIG. 10, and identifies the determination “judged by administrator” that corresponds to the patch type “OS” and a condition “function of middleware or application exists that accesses resource to be corrected that is to be accessed by patch”. Then, the determination unit 22 sets the determination result of the patch cross-check result DB 18 to being “judged by administrator”. By doing as described above, the determination unit 22 determines to leave the application of the patch O2 to the virtual server A to the judgment of an administrator.

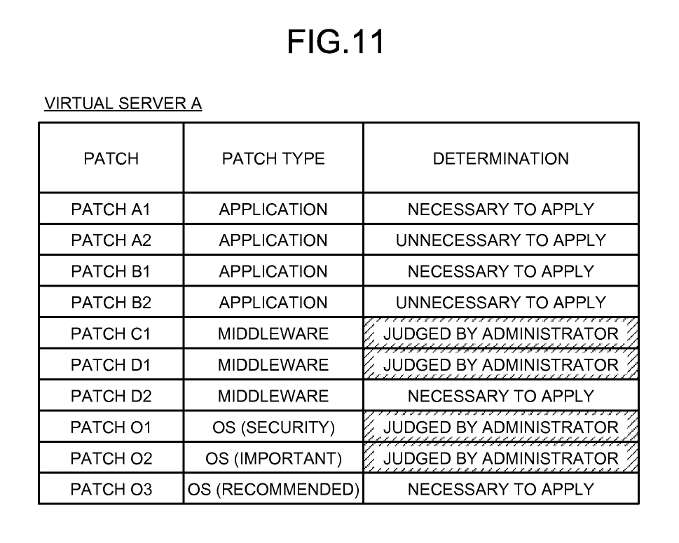

Referring back to FIG. 2, the display controller 23 is a processing unit that displays the patch cross-check result made by the determination unit 22 on the display unit 12. Specifically, the display controller 23 displays, on the display unit 12, the patch determination result stored in the patch cross-check result DB 18 for each of the virtual servers 50. FIG. 11 is a diagram illustrating display examples displayed on the display unit. As illustrated in FIG. 11, the display controller 23 displays items of “patch, patch type, and determination” for each of the virtual servers 50 in a mutually corresponding manner.

The “patch” displayed here is set with a name of a patch stored in the patch cross-check result DB 18, and the “patch type” is set with the type of the patch stored in the patch cross-check result DB 18. The “determination” is set with the content of the “determination result” that is stored in the patch cross-check result DB 18 on a patch-by-patch basis. FIG. 11 illustrates that the following patches are determined as being “judged by administrator”: the patch C1 serving as a patch for the middleware, a patch D1 serving as a patch for the middleware, the patch O1 serving as a security patch for the OS, and the patch O2 serving as an important patch for the OS.

The display controller 23 can also display detailed information when the user selects the information displayed on the display unit 12. For example, when “patch C1” is selected out of the display examples illustrated in FIG. 11, the display controller 23 acquires a detail table corresponding to the selected “patch C1” from the patch cross-check result DB 18, and displays the acquired detail table on the display unit 12.

Configuration of Clone Master

As illustrated in FIG. 2, the clone master 30 includes a communication control interface 31, a function definition DB 32, a function definition unit 33, a log collection unit 34, a function resource identification unit 35, and a patch resource identification unit 36. Note that the function definition DB 32 is stored in a storage device such as a memory, a hard disk, or the like. Each of the processing units is executed by a CPU or the like.

The communication control interface 31 is a processing unit that controls communication with other servers. For example, the communication control interface 31 sends a result of function definition, an execution result of patching, and the like to the administration server 10, and receives an execution instruction of patching from the administration server 10.

The function definition DB 32 is a storage unit that stores the definitions about the available functions installed on the clone master 30. In other words, the information stored in the function definition DB 32 is sent to the administration server 10, and is stored in the function definition DB 13. Accordingly, the information stored in the function definition DB 32 is the same as the information stored in the function definition DB 13, and therefore detail description thereof will be omitted.

The function definition unit 33 is a processing unit that executes, based on, for example, an instruction from the administration server 10, definitions on functions executable on the clone master 30. Specifically, upon accepting an instruction operation of the administrator or the like, the function definition unit 33 checks to find functions executable by software on the clone master 30, and defines the items illustrated in FIG. 3 for each of the functions. Then, the function definition unit 33 stores results of the definition in the function definition DB 32. The function definition unit 33 also sends the information stored in the function definition DB 32 to the administration server 10, based on, for example, an instruction from the administration server 10.

The log collection unit 34 is a processing unit that collects event logs and log files that are output on the clone master 30. The log collection unit 34 is a function unit that is to be established on the virtual servers 50 deployed from the clone master 30, and is not necessarily executed on the clone master 30.

The function resource identification unit 35 is a processing unit that identifies information on resources used by functions executed on the clone master 30. Specifically, based on an instruction operation from the administration server 10, the function resource identification unit 35 executes each of the functions of each piece of software on the clone master 30 to identify resources used by the functions, and sends results of the execution to the administration server 10. For example, the function resource identification unit 35 executes each of the functions of each piece of software, and monitors each of the functions. Then, the function resource identification unit 35 identifies names of files, registries, and services used by the functions.

The patch resource identification unit 36 is a processing unit that executes released patches on the clone master 30 to identify resources accessed by the patches. Specifically, the patch resource identification unit 36 acquires the released patches from the administration server 10, and based on an instruction operation from the administration server 10, executes a program for applying each of the patches on the clone master 30. Then, the patch resource identification unit 36 identifies the resources accessed by each of the patches, and sends the result to the administration server 10. For example, the patch resource identification unit 36 executes the program for applying each of the patches and monitors the behavior of each of the patches. Then, the patch resource identification unit 36 identifies names of files, registries, and services accessed by the patches.

Configurations of Virtual Servers

Next, configurations of the virtual servers A to D will be described. Here, however, the virtual servers will be described as the virtual servers 50 because all of them have the same configuration. Note that, although all of the virtual servers have the same configuration, the functions executed thereon are not necessarily the same as each other.

As illustrated in FIG. 2, the virtual server 50 is a virtual server deployed as a copy of the clone master 30 serving as the copy source, and therefore has the same configuration as that of the clone master 30. In other words, the virtual server 50 includes a communication control interface 51, a function definition DB 52, a function definition unit 53, a log collection unit 54, a function resource identification unit 55, and a patch resource identification unit 56. Note that the function definition DB 52 is stored in a storage device such as a memory, a hard disk, or the like. Each of the processing units is executed by a CPU or the like.

Among these units, the function definition DB 52, the function definition unit 53, the function resource identification unit 55, and the patch resource identification unit 56 are included in the clone master 30 and deployed to the virtual server 50. Accordingly, those units are not necessarily included in the virtual server 50, and therefore detail description thereof will be omitted.

The communication control interface 51 is a processing unit that controls communication with other servers. For example, the communication control interface 51 receives a log acquisition request from the administration server 10, and sends a log to the administration server 10.

The log collection unit 54 is a processing unit that collects event logs and log files that are output on the virtual server 50. Specifically, the log collection unit 54 may periodically collect the event logs and the log files, and send them to the administration server 10, or may collect and send them when requested from the administration server 10.

For example, the log collection unit 54 periodically exports and sends the event logs of the virtual server 50 to the administration server 10. In addition, the log collection unit 54 acquires, on the virtual server 50, output log files stored in the function definition DB 52 or output log files specified by the administration server 10, and sends the acquired output log files to the administration server 10.

Flows of Processes

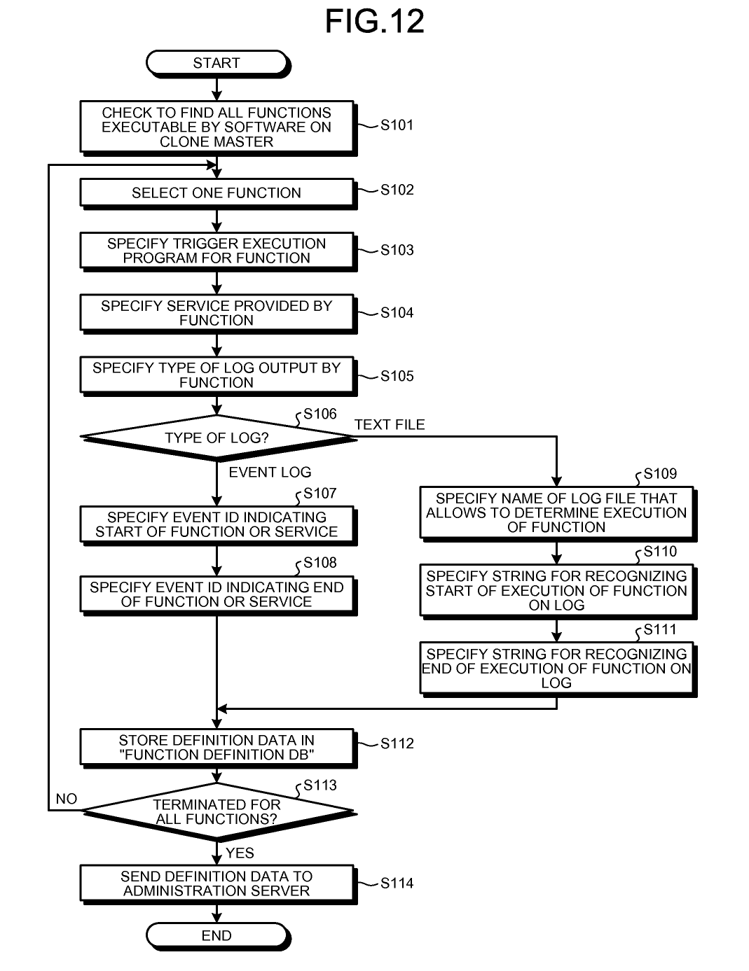

Next, using FIGS. 12 to 17, a description will be made of the processes executed in the system illustrated in FIG. 1. Note that the same processes are executed among the virtual servers, and therefore, the processes executed by each of the virtual servers are described as executed by the virtual server 50.

Function Definition Process

FIG. 12 is a flowchart illustrating a flow of the function definition process. The clone master 30 executes this process on a software-by-software basis. Note that the timing of starting the process can be such that the process is executed periodically, or can be such that the process is executed based on an instruction operation from the administration server 10. Note also that this process is executed upon acceptance of an instruction of the administrator. Executing the process of FIG. 12 generates the information to be stored in the function definition DB 13 and the function definition DB 32.

As illustrated in FIG. 12, the function definition unit 33 of the clone master 30 checks to find all of the functions executable by the software on the clone master 30 (S101). Subsequently, the function definition unit 33 selects one function from the found functions (S102). The software and the function thereof selected here correspond to the “software name” and the “function” illustrated in FIG. 3.

Subsequently, the function definition unit 33 accepts a specification of a trigger execution program for the selected function (S103). The trigger execution program accepted here corresponds to the “function trigger execution program” illustrated in FIG. 3. A plurality of program names can be accepted here.

Then, the function definition unit 33 accepts a specification of a service provided by the selected function (S104). The service accepted here corresponds to the “service” illustrated in FIG. 3. If the function provides no service, nothing is stored at this step.

Subsequently, the function definition unit 33 accepts a specification of a type of a log output by the selected function (S105). The type of the output log accepted here corresponds to the “log type” illustrated in FIG. 3.

Then, if the specified type of the log is the event log type (Event log at S106), the function definition unit 33 accepts specifications of an event ID indicating the start of the function or the service and of an event ID indicating the end of the function or the service (S107 and S108). The event IDs accepted here correspond to the “start event ID” and the “end event ID” illustrated in FIG. 3.

If, instead, the specified type of the log is the text file type (Text file at S106), the function definition unit 33 accepts a specification of a name of a log file that allows to determine execution of the function (S109). The function definition unit 33 also accepts a string for recognizing the start of execution of the function on the log and a string for recognizing the end of execution of the function on the log (S110 and S111). The event log file name accepted here corresponds to the “output log file” illustrated in FIG. 3. Also, the string for recognizing the start of execution corresponds to the “start identification string” illustrated in FIG. 3, and the string for recognizing the end of execution corresponds to the “end identification string” illustrated in FIG. 3.

Thereafter, the function definition unit 33 stores the definition data specified at steps S102 to S111 in the function definition DB 32 (S112). Then, the function definition unit 33 determines whether the process is terminated for all functions of the software (S113), and, if there are any unprocessed functions (No at S113), the function definition unit 33 returns to S102, and executes S102 and later for the unprocessed functions.

If, instead, there is no unprocessed function (Yes at S113), the function definition unit 33 sends the definition data to be stored in the function definition DB 13 to the administration server 10 (S114), and terminates the process.

Function Use Resource Identification Process

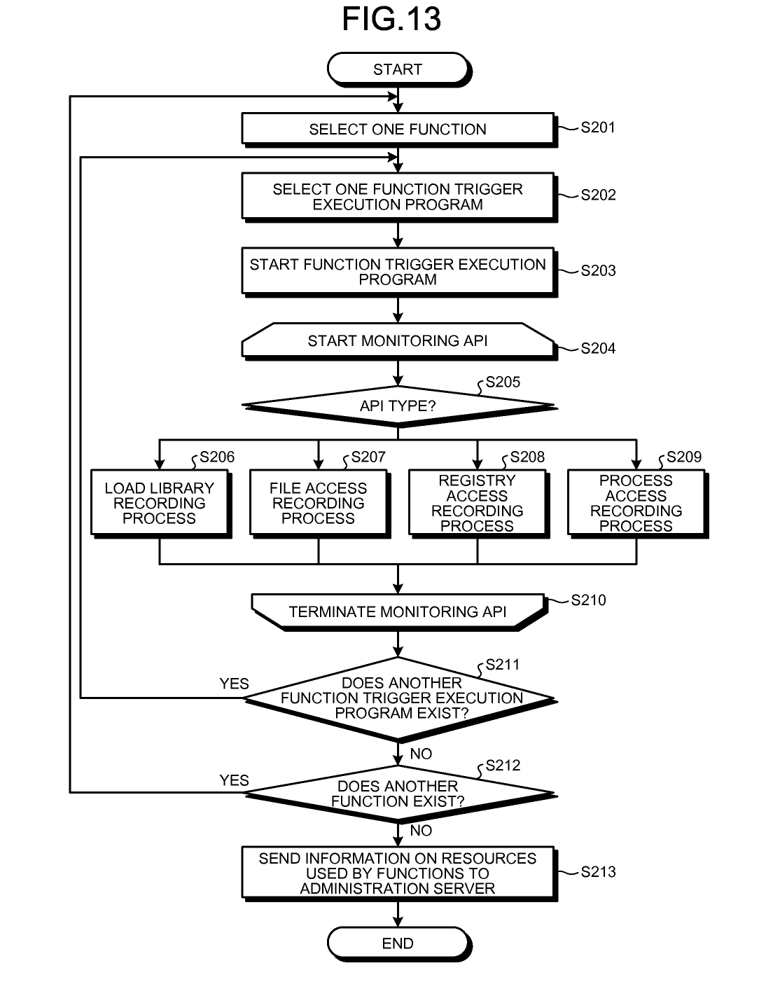

FIG. 13 is a flowchart illustrating a flow of the process to identify the resources used by the functions. This process is executed by the clone master 30 on a software-by-software basis. The timing of starting the process can be such that the process is executed periodically, or can be such that the process is executed based on an instruction operation from the administration server 10. By executing the process of FIG. 13, the function use resource DB 14 stores therein information.

The function resource identification unit 35 of the clone master 30 selects one function corresponding to software to be processed from the function definition DB 32 illustrated in FIG. 3 (S201). The software and the function selected here correspond to the “software name” and the “function” illustrated in FIG. 4.

Subsequently, the function resource identification unit 35 selects one function trigger execution program for the function selected at 5201 from the function definition DB 32 illustrated in FIG. 3 and starts the selected function trigger execution program (S202 and S203), and starts monitoring an application programming interface (API) (S204). The function trigger execution program selected here corresponds to the “function trigger execution program” illustrated in FIG. 3.

Thereafter, the function resource identification unit 35 monitors the API and repeatedly executes various recording processes corresponding to the API types until the execution program ends (from S205 to S210).

Specifically, if, for example, load of a library occurs, the function resource identification unit 35 executes a load library recording process (S206). For example, the function resource identification unit 35 acquires the file name of the loaded library or the like. The file name acquired here corresponds to the “file” illustrated in FIG. 4. Note that the file name of the executed function trigger execution program corresponds to the “file” illustrated in FIG. 4.

If access to a file occurs, the function resource identification unit 35 executes a file access recording process (S207). For example, the function resource identification unit 35 acquires the file name of the file that is referred to or modified. The file name acquired here corresponds to the “file” illustrated in FIG. 4.

If access to a registry occurs, the function resource identification unit 35 executes a registry access recording process (S208). For example, the function resource identification unit 35 acquires the name of the registry that is referred to or modified. The registry name acquired here corresponds to the “registry” illustrated in FIG. 4.

If communication with a service occurs, the function resource identification unit 35 executes a process access recording process (S209). For example, the function resource identification unit 35 acquires the name of the service with which the communication is done. The service name acquired here corresponds to the “service” illustrated in FIG. 4.

Thereafter, when the API has ended, the function resource identification unit 35 refers to the function definition DB 32 illustrated in FIG. 3, and determines whether any other function trigger execution program exists that corresponds to the function to be processed selected at 5201 (S211).

Then, if determining that another function trigger execution program exists (Yes at S211), the function resource identification unit 35 repeats the process at S202 and later. If, instead, determining that no other function trigger execution program exists (No at S211), the function resource identification unit 35 refers to the function definition DB 32 illustrated in FIG. 3, and determines whether any other function exists in the software to be processed (S212). In other words, the function resource identification unit 35 determines whether any unprocessed function exists in the process illustrated in FIG. 12.

Then, if determining that another function, that is, an unprocessed function, exists (Yes at S212), the function resource identification unit 35 repeats S201 and later. If, instead, determining that no other function, that is, no unprocessed function, exists (No at S212), the function resource identification unit 35 sends the information acquired from S201 to S212 on the resources used by the functions to the administration server 10 (S213), and terminates the process.

Log Collection Process

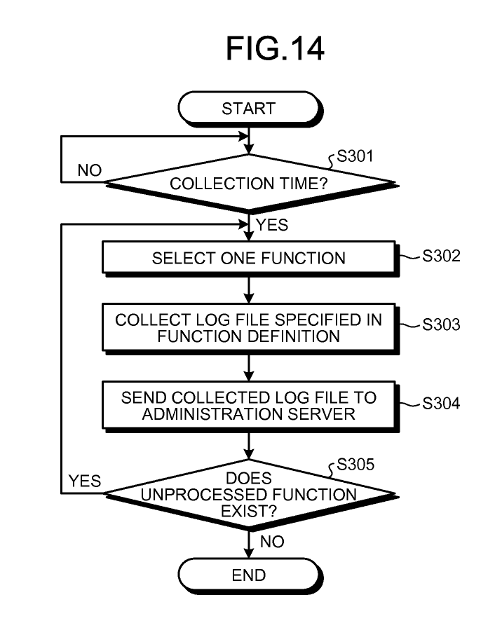

FIG. 14 is a flowchart illustrating a flow of the process to collect the logs. This process is executed by the virtual servers 50. The timing of starting the process can be such that the process is executed periodically, or can be such that the process is executed based on an instruction operation from the administration server 10. By executing the process of FIG. 14, the function log DB 15 stores therein information.

As illustrated in FIG. 14, when a collection time arrives (Yes at S301), the log collection unit 54 of the virtual servers 50 selects one function from the function definition DB 52 illustrated in FIG. 3 (S302). Note that the function definition DB 52 is assumed to be synchronized with the function definition DB 32 of the clone master 30 at intervals specified in advance. The log collection unit 54 of the virtual servers 50 may also acquire information from the clone master 30 as to selection of a function.

Then, the log collection unit 54 refers to the function definition DB 52 illustrated in FIG. 3, and collects the log file corresponding to the function selected at S302 (S303). At this time, if the log file corresponding to the function selected at S302 is an event log file, log collection unit 54 exports the log file as a text file.

Subsequently, the log collection unit 54 sends the collected log file to the administration server 10 (S304). At this time, the log collection unit 54 may send, in addition to the log file, information such as the log file name, the name of the virtual server as the collection source, and information on the software and the function outputting the logs to the log file.

Thereafter, if determining that another unprocessed function exists (Yes at S305), the log collection unit 54 repeats the process at S302 and later. If, instead, determining that no other unprocessed function exists (No at S305), the log collection unit 54 terminates the process.

Used Function Analysis Process

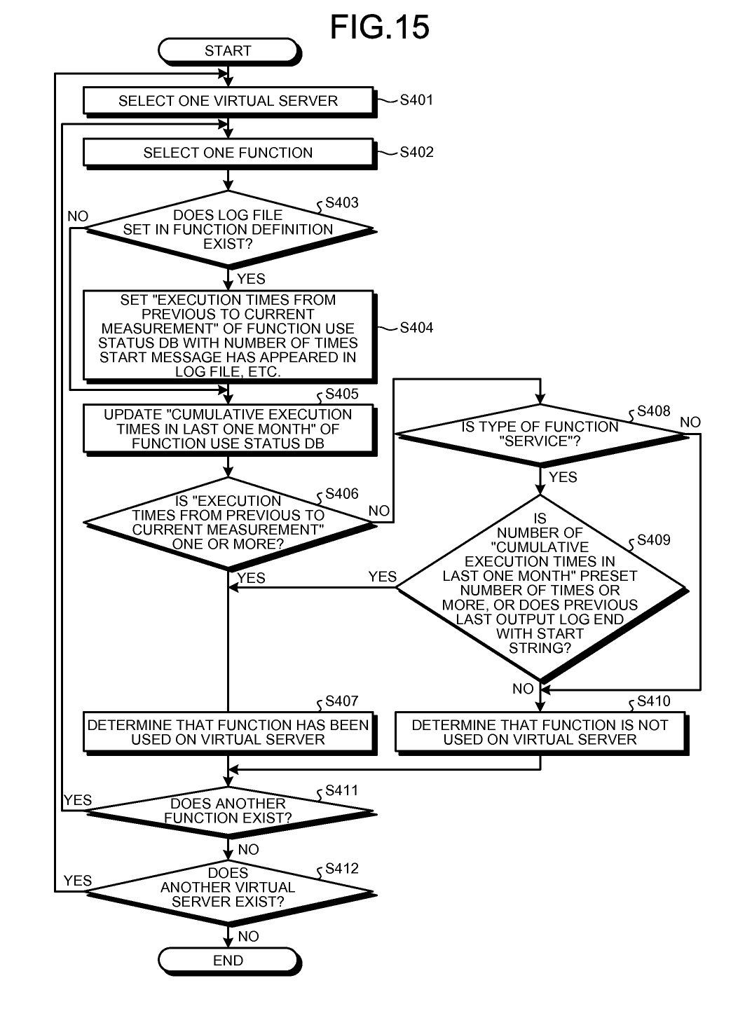

FIG. 15 is a flowchart illustrating a flow of the process to analyze the used functions. This process is executed by the administration server 10. The timing of starting the process can be such that the process is executed periodically, or can be such that the process is executed when a patch is released. By executing the process of FIG. 15, the function use status DB 16 stores therein information.

As illustrated in FIG. 15, the identification unit 20 of the administration server 10 selects one of the virtual servers 50 to be patched (S401), and selects one function of a piece of software with reference to the function definition DB 13 (S402). The software and the function thereof selected here correspond to the “software name” and the “function” of the function use status DB 16 illustrated in FIG. 6. At this time, the identification unit 20 also identifies a service name with reference to the function definition DB 13.

Subsequently, the identification unit 20 refers to the function definition DB 13 illustrated in FIG. 3, and determines whether the function log DB 15 stores an output log file or text data of event logs corresponding to the function selected at S402 (S403).

Then, if determining that the function log DB 15 stores the log file or the like (Yes at S403), the identification unit 20 sets the “execution times from previous to current measurement” of the function use status DB 16 with the number of times a start message has appeared in the log file or the like (S404). For example, the identification unit 20 counts the number of times the “start identification string” of the function definition DB 13 illustrated in FIG. 3 has appeared in the log file, and sets the counted number of times in the function use status DB 16. The identification unit 20 also counts the number of times the “start event ID” of the function definition DB 13 illustrated in FIG. 3 has appeared in the text file of event logs, and sets the counted number of times in the function use status DB 16.

Subsequently, the identification unit 20 updates the “cumulative execution times in last one month” of the function use status DB 16 (S405). For example, the identification unit 20 adds the number of times counted at S404 to the current value of the “cumulative execution times in last one month”. Note that, if determining that the function log DB 15 does not store the log file or the like (No at S403), the identification unit 20 executes S405 without executing S404. In other words, the number of “cumulative execution times in last one month” is not updated in this case.

Thereafter, the identification unit 20 determines whether the “execution times from previous to current measurement” of the updated function use status DB 16 is one or more (S406). Then, if determining that the “execution times from previous to current measurement” is one or more (Yes at S406), the identification unit 20 determines that the function has been used on the virtual server 50 (S407). Specifically, the identification unit 20 sets the “function in use” corresponding to the function selected at S402 with “O” in the function use status DB 16 illustrated in FIG. 6.

If, instead, determining that the “execution times from previous to current measurement” is not one or more (No at S406), the identification unit 20 refers to the function use status DB 16 or the function definition DB 13, and determines whether the type of the function is the service type (S408). In other words, the identification unit 20 determines, with reference to the function use status DB 16 or the function definition DB 13, whether a service corresponds to the currently selected function.

Then, if determining that the type of the function is the service type (Yes at S408), the identification unit 20 executes a determination of S409. Specifically, the identification unit 20 determines whether the number of “cumulative execution times in last one month” is a preset number of times or more, or the previous last output ends with the start identification string (start event ID).

Thereafter, if determining that the condition of S409 is fulfilled (Yes at S409), the identification unit 20 determines that the function is used on the virtual server (S407). If, instead, determining that the condition of S409 is not fulfilled (No at S409), the identification unit 20 determines that the function is not used on the virtual server 50 (S410). In this case, the identification unit 20 sets the “function in use” corresponding to the function selected at S402 with “X” in the function use status DB 16 illustrated in FIG. 6.

If determining, at S408, that the type of the function is not the service type (No at S408), the identification unit 20 determines that the function is not used on the virtual server 50 (S410). Specifically, the identification unit 20 sets the “function in use” corresponding to the function selected at S402 with “X” in the function use status DB 16 illustrated in FIG. 6.

Thereafter, if any other function exists, that is, any unprocessed function remains, on the currently selected virtual server 50 (Yes at S411), the identification unit 20 repeats S402 and later. If, instead, no other function exists, that is, no unprocessed function remains, on the currently selected virtual server 50 (No at S411), the identification unit 20 determines whether any other virtual server 50 exists (S412).

Then, if any other virtual server 50 exists, that is, any unprocessed virtual server 50 remains (Yes at S412), the identification unit 20 repeats S401 and later. If, instead, no other virtual server 50 exists, that is, no unprocessed virtual server 50 remains (No at S412), the identification unit 20 terminates the process.

Patch Access Identification Process

FIG. 16 is a flowchart illustrating a flow of the process to identify the resources accessed by the patches. This process is executed on the clone master 30 by the administration server 10. The process can be started when an instruction operation of the administrator is accepted, or when the patches are released. By executing the process of FIG. 16, the patch access resource DB 17 stores therein information.

As illustrated in FIG. 16, the identification unit 20 of the administration server 10 acquires patches released from the patch release server 1, and selects one of the released patches in the order of release (S501). The name of the released patch selected here corresponds to the “patch” of the patch access resource DB 17 illustrated in FIG. 7. In the same manner, the type of the selected released patch corresponds to the “patch type” of the patch access resource DB 17 illustrated in FIG. 7. In the same manner, the importance of the selected released patch corresponds to the “patch importance” of the patch access resource DB 17 illustrated in FIG. 7.

Then, the identification unit 20 of the administration server 10 makes the clone master 30 start the program for applying the selected released patch (S502). Specifically, the identification unit 20 of the administration server 10 stores the released patch in the clone master 30, and the patch resource identification unit 36 of the clone master 30 executes the program for applying the released patch.

Thereafter, after starting applying the released patch, the patch resource identification unit 36 of the clone master 30 monitors the API, and repeatedly executes various recording processes corresponding to the API types until the application of the released patch ends (from S503 to S508).

Specifically, if access to a file occurs, the patch resource identification unit 36 executes a file access recording process (S505). For example, the patch resource identification unit 36 acquires the file name of the file that is referred to or modified. The file name acquired here corresponds to the “file” illustrated in FIG. 7.

If access to a registry occurs, the patch resource identification unit 36 executes a registry access recording process (S506). For example, the patch resource identification unit 36 acquires the name of the registry that is referred to or modified. The registry name acquired here corresponds to the “registry” illustrated in FIG. 7.

If start or stop of a service occurs, the patch resource identification unit 36 executes a process access recording process (S507). For example, the patch resource identification unit 36 acquires the name of the service that has started or stopped. The service name acquired here corresponds to the “service” illustrated in FIG. 7.

Thereafter, when the API has ended, the patch resource identification unit 36 determines whether the process is terminated for all of the released patches (S509). Specifically, the patch resource identification unit 36 inquires the identification unit 20 of the administration server 10 as to whether the process is terminated for all of the released patches.

Then, if any unprocessed released patch exists (No at S509), the process at S501 and later is executed. If, instead, no unprocessed released patch exists (Yes at S509), the patch resource identification unit 36 sends, to the administration server 10, the information on the resources identified in the process from S501 to S509 that are accessed by the released patches (S510).

Patch Application Determination Process

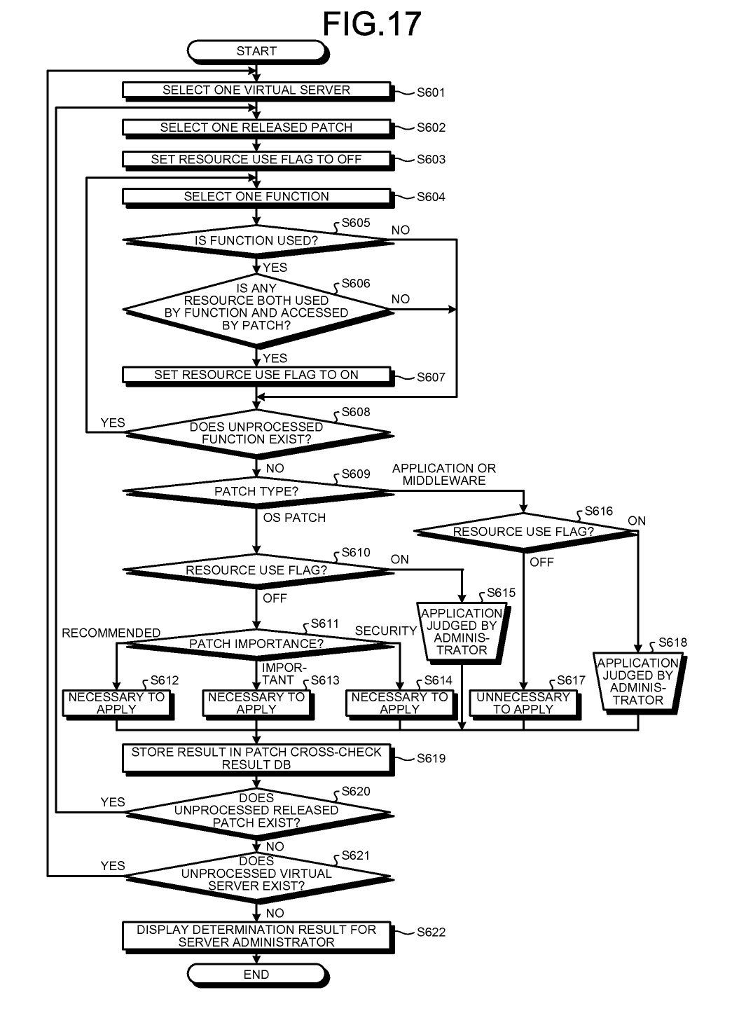

FIG. 17 is a flowchart illustrating a flow of the process to determine whether patches are to be applied. This process is executed by the administration server 10. The timing of starting the process can be such that the process is executed periodically, or can be such that the process is executed when the patch access resource DB 17 is updated. By executing the process of FIG. 17, the patch cross-check result DB 18 stores therein information.

As illustrated in FIG. 17, the determination unit 22 of the administration server 10 selects one of the virtual servers 50 (S601), and selects one of the released patches (S602). The cross-check result illustrated in FIG. 8 is generated for each name of the released patch selected here.

Subsequently, the determination unit 22 sets the resource use flag to OFF as an initial value (S603). Then, the determination unit 22 selects one function from the function use status DB 16 illustrated in FIG. 6 for each of the virtual servers 50 (S604). The software and the function thereof selected here correspond to the “software name” and the “function” of the patch cross-check result DB 18 illustrated in FIG. 8.

Then, the determination unit 22 determines whether the selected function is used (S605). Specifically, the determination unit 22 refers to the function use status DB 16 illustrated in FIG. 6 for each of the virtual servers 50, and determines that the function is used if the “function in use” corresponding to the selected function is set with “O”.

Subsequently, if determining that the selected function is used (Yes at S605), the determination unit 22 determines whether any resource is both used by the selected function and accessed by the released patch (S606). Specifically, the determination unit 22 identifies names of files, registries, and services used by the selected functions with reference to the function use resource DB 14 illustrated in FIG. 4. The determination unit 22 also identifies names of files, registries, and services accessed by the patch to be checked with reference to the patch access resource DB 17 illustrated in FIG. 7. Then, the determination unit 22 compares the identified names of the files, the registries, and the services between both of the resource DBs, and determines whether there is a coincident name.

Subsequently, if determining that there is a resource that is both used by the selected function and accessed by the released patch (Yes at S606), the determination unit 22 sets the “resource use flag” in the cross-check result for the patch to “ON” (S607). Note that the names of the files, the registries, and the services determined here to be coincident correspond to the file names, the registry names, and the service names of the cross-check result illustrated in FIG. 8.

If, instead, determining that the selected function is not used (No at S605), the determination unit 22 keeps the “resource use flag” to be “OFF”, and executes S608. If determining that there is no resource that is both used by the selected function and accessed by the released patch (No at S606), the determination unit 22 also keeps the “resource use flag” to be “OFF”.

Thereafter, if any unprocessed function exists in the function use status DB 16 illustrated in FIG. 6 for each of the virtual servers 50 (Yes at S608), the determination unit 22 repeats the process at S604 and later.

Then, if no unprocessed function exists (No at S608), the determination unit 22 refers to the patch access resource DB 17 illustrated in FIG. 7, and determines the type of the currently selected released patch (S609).

If the type of the currently selected released patch is “OS” (OS patch at S609), the determination unit 22 determines whether the resource use flag is currently ON or OFF (S610). Then, if determining that the resource use flag is currently OFF (OFF at S610), the determination unit 22 refers to the patch access resource DB 17 illustrated in FIG. 7, and identifies the importance of the currently selected patch (S611).

In the example illustrated in FIG. 17, the determination unit 22 determines the result to be “necessary to apply” in any case in which the importance of the patch is “recommended”, important”, or “security” (from S612 to S614). The result determined here corresponds to the “determination result” of the patch cross-check result DB 18 illustrated in FIG. 8.

If, instead, determining that the resource use flag is currently ON (ON at S610), the determination unit 22 determines the result to be an “application judged by administrator” (S615). The result determined here corresponds to the “determination result” of the patch cross-check result DB 18 illustrated in FIG. 8.

If, at S609, the type of the currently selected released patch is “application” or “middleware” (S609), the determination unit 22 determines whether the resource use flag is currently ON or OFF (S616).

Then, if determining that the resource use flag is currently OFF (OFF at S616), the determination unit 22 determines the result to be “unnecessary to apply” (S617). The result determined here corresponds to the “determination result” of the patch cross-check result DB 18 illustrated in FIG. 8.

If, instead, determining that the resource use flag is currently ON (ON at S616), the determination unit 22 determines the result to be an “application judged by administrator” (S618). The result determined here corresponds to the “determination result” of the patch cross-check result DB 18 illustrated in FIG. 8.

Thereafter, the determination unit 22 stores, in the patch cross-check result DB 18, the determination result of whether to apply the patch on the virtual server 50 determined in the process from S601 to S618 (S619). Then, if any unprocessed released patch exists (Yes at S620), the determination unit 22 repeats the process at S602 and later. If no unprocessed released patch exists (No at S620) and any unprocessed virtual server 50 exists (Yes at S621), the determination unit 22 repeats the process at S601 and later.

If, instead, no unprocessed virtual server 50 exists (No at S621), the determination unit 22 displays the determination result for the server administrator (S622). In other words, when the determination unit 22 has finished making the determination, the display controller 23 displays, on the display unit 12, the information stored in the patch cross-check result DB 18.

By executing the processes described above, it is possible to extract patches that corrects functions used in a task, and in addition, to identify whether the patches affect other software, middleware, or applications using the functions to be corrected by the patches. For actual operation, before being applied to an actual operating environment, all of the patches are applied at a time to a test environment and are verified. If a problem occurs at this time, functions influenced by each of the patches are found. Thus, the range of investigation can be identified.

In addition, it is possible to identify the influence on the task caused by the application of the released patches, without knowing the source code or constituent modules of the OS or the software installed on the servers to be patched. Moreover, applicability of the patches can be determined on the virtual servers 50 in operation without using methods causing to impose loads to the virtual servers 50, such as a method in which a program for monitoring the resources used stays resident.

### [b] Second Embodiment

While the embodiment of the present invention has been described above, the present invention can be implemented in various embodiments in addition to the above-described embodiment. Therefore, another embodiment will be described below.

Application to Physical Servers

While the first embodiment has been described as an example of the case of applying the patches to the virtual servers 50, the present invention is not limited to this case, and the same processing can be applied to physical servers. In addition, a test machine or the like built in the test environment may be used to execute the processes to be executed on the clone master 30, such as the process to identify the resources accessed by the patches and the process to identify the resources used by the functions.

Identification of Resources

While, in the first embodiment, the example has been described in which the clone master 30 is used to identify the resource information on resources used by the functions and the resource information on resources accessed by the patches, the present invention is not limited to this example. For example, if the resource information is known in advance based on program design or the like, is it possible to use the information. Also, once the resource information on the resources used by the functions has been identified, the process of identifying the resource information on the resources used by the functions may be omitted thereafter until any function is changed.

System

It is also possible to manually execute, among the processes described in the first embodiment, all or a part of the processes that have been described to be automatically executed. It is also possible to automatically execute, using a known method or methods, all or a part of the processes that have been described to be manually executed. In addition, unless otherwise noted, it is possible to optionally change the processing procedures, the control procedures, the specific names, and the information including various data and parameters illustrated in the above-described document and the drawings.

The components of the apparatuses illustrated are represented as functional concepts, and are not necessarily physically configured as illustrated. In other words, specific forms of distribution and integration of the apparatuses are not limited to those illustrated in the figures. That is to say, all or a part of the apparatuses can be configured so as to be functionally or physically distributed or integrated in any unit according to various loads and states of use. Furthermore, all or a part of the processing functions executed in the apparatuses can be implemented by a CPU and a program analyzed and executed by the CPU, or can be implemented as hardware based on a wired logic.

Hardware

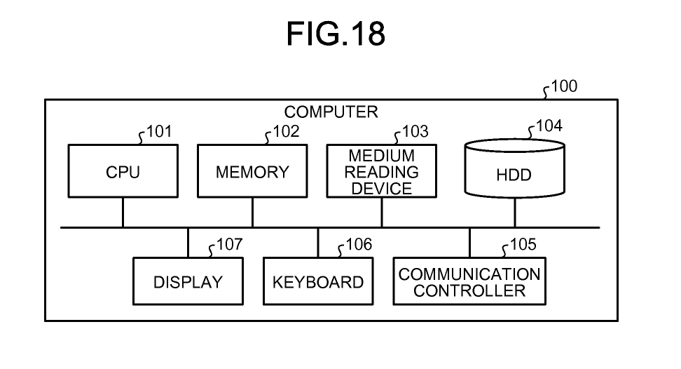

FIG. 18 is a diagram illustrating a hardware configuration example of a computer. The hardware configuration illustrated here corresponds to each of the apparatuses illustrated in FIG. 1. As illustrated in FIG. 18, a computer 100 includes a CPU 101, a memory 102, a medium reading device 103, a hard disk drive (HDD) 104, a communication controller 105, a keyboard 106, and a display 107. The units illustrated in FIG. 18 are connected to each other via a bus.

The keyboard 106 is an input device; the display 107 is an output device; and the communication controller 105 is an interface such as a network interface card (NIC). The HDD 104 stores the programs that execute the functions illustrated in FIG. 2 and other figures and the DBs illustrated in FIG. 2. Although the HDD 104 is taken as an example of a recording medium, the various programs may be stored on another computer-readable recording medium such as a read-only memory (ROM), a RAM, or a CD-ROM, and may be read into the computer. Alternatively, the recording medium may be located at a remote place, and the computer may access the recording medium to acquire and use the programs. In that case, the acquired programs may be stored on a recording medium of the computer itself and used.

The CPU 101 reads, from the HDD 104 or the like, a program executing the same processes as those of the processing units illustrated in FIG. 2 and loads the program in the memory 102 so as to operate a process of executing the functions described using FIG. 2 and other figures. In other words, if the computer 100 is the administration server 10, this process executes the same functions as those included in the administration server 10. If, instead, the computer 100 is the clone master 30, this process executes the same functions as those included in the clone master 30. If, otherwise, the computer 100 is the virtual server 50, this process executes the same functions as those included in the virtual server 50. In this manner, the computer 100 reads and executes the program so as to operate as the information processing apparatus that executes the patch determination program.

The computer 100 can also read the program mentioned above from a recording medium by using the medium reading device 103 and then execute the above-mentioned program thus read so as to implement the same functions as those of the above-described embodiment. Note that the program mentioned in other embodiments is not limited to be executed by the computer 100. The present invention can be applied, for example, to a case in which another computer or server executes the program, or to a case in which these computers or servers cooperate to execute the program.

According to an aspect of an embodiment of the present invention, problems can be prevented from occurring due to application of a patch.

All examples and conditional language recited herein are intended for pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A non-transitory computer-readable recording medium having stored therein a patch determination program causing a computer to execute a process comprising:
first acquiring first resource information on a resource used by a function executed on an information processing apparatus to which a patch is to be applied;
second acquiring second resource information on a resource accessed by the patch when the patch is executed; and
determining whether to apply the patch, based on the first resource information acquired at the first acquiring and the second resource information acquired at the second acquiring.

2. The computer-readable recording medium according to claim 1, wherein the process further comprises:
identifying information on resources accessed by each function is to be executed in the information processing apparatus to which the patch is to be applied, by executing the each function in another information processing apparatus; and
collecting logs output by the functions on the information processing apparatus to which the patch is to be applied; wherein
the first acquiring includes extracting a function operating on the information processing apparatus to which the patch is to be applied from the collected logs and acquiring information on resources used by the extracted function from the information on the resources accessed by the each function.

3. The computer-readable recording medium according to claim 1, wherein the determining includes inquiring an administrator, when the function executed on the information processing apparatus uses the resource accessed by the patch, as to whether to apply the patch, based on the first resource information and the second resource information.

4. The computer-readable recording medium according to claim 1, wherein the process further comprises:
displaying, on a predetermined display unit, a determination result obtained at the determining whether to apply the patch.

5. The computer-readable recording medium according to claim 4, wherein the displaying includes displaying, when the determination result of whether to apply the patch displayed on the predetermined display unit is selected, the resource accessed by the patch on the predetermined display unit, based on the first resource information and the second resource information.

6. A patch determination method comprising:
first acquiring first resource information on a resource used by a function executed on an information processing apparatus to which a patch is to be applied;
second acquiring second resource information on a resource accessed by the patch when the patch is executed; and
determining whether to apply the patch, based on the first resource information acquired at the first acquiring and the second resource information acquired at the second acquiring.

7. An information processing apparatus comprising:
a processor configured to acquire first resource information on a resource used by a function executed on an information processing apparatus to which a patch is to be applied;
acquire second resource information on a resource accessed by the patch when the patch is executed; and
determine whether to apply the patch, based on the first resource information acquired and the second resource information acquired.
